(19) United States
(12) Patent Application Publication
(10) Pub. No.: US 2026/0299522 A1
(43) Pub. Date: Oct. 1, 2026

(54) REMOTE SAFETY I/O DEVICE

(71) Applicant: Banner Engineering Corp., Minneapolis, MN (US)

(72) Inventors: John Klesk, Minneapolis, MN (US); Dmitry Gringauz, Minneapolis, MN (US); Dean Erickson, Minneapolis, MN (US)

(73) Assignee: Banner Engineering Corp., Minneapolis, MN (US)

(21) Appl. No.: 19/490,188

(22) PCT Filed: Jun. 16, 2023
(86) PCT No.: PCT/US2023/068625

§ 371 Date: Dec. 4, 2025

(51) Int. Cl. G05B 9/02

(52) U.S. Cl. CPC G05B 9/02

(57) ABSTRACT

Apparatus and associated methods relate to a remote safety input/output device configured to deliver both safety signals and sensor level diagnostics signals in an industrial safety communication network. In an illustrative example, a safety communication device (SCD) may include a safety port operably coupled to serially connected safety devices. The (SCD) may include pre-loaded safety signal profiles (SSPs) and an input system detection engine (ISDE). The ISDE may, for example, automatically identify a device type and a topological configuration of the serially connected safety devices based on a signal received at the safety port and the pre-loaded SSP. For example, when a safety device signal is received at the safety port, the ISDE may automatically identify whether the signal is a safety signal or a diagnostic signal. Various embodiments may advantageously provide plug-and-play installation of the safety devices to the industrial safety communication network.

### CROSS-REFERENCE TO RELATED APPLICATIONS

The subject matter of this application may have common inventorship with and/or may be related to the subject matter of the following:
U.S. patent application Ser. No. 18/152,648, titled “Methods to Generate a Wiring Schema,” filed by John Klesk, et al., on Jan. 10, 2023, which is a continuation of U.S. patent application Ser. No. 17/583,720, titled “Methods to Generate a Wiring Schema,” filed by John Klesk, et al., on Jan. 25, 2022, which is a continuation of U.S. patent application Ser. No. 16/508,137, titled “Methods to Generate a Wiring Schema,” filed by John Klesk, et al., on Jul. 10, 2019.
PCT Patent Application Serial No. PCT/US20/41511, titled “Methods to Configure a Safety Control System,” filed by John Klesk, et al., on Jul. 10, 2020.
U.S. patent application Ser. No. 17/646,760, titled “Methods to Configure a Safety Control System,” filed by John Klesk, et al., on Jan. 3, 2022, which is a continuation of U.S. patent application Ser. No. 16/508,134, titled “Methods to Configure a Safety Control System,” filed by John Klesk, et al., on Jul. 10, 2019.
U.S. Design Patent Application Ser. No. 29/696,420, titled “Safety Controller,” filed by John Klesk, et al., on Jun. 27, 2019.
U.S. Provisional Application Ser. No. 63/479,316, titled “Safety Thermal Imaging Camera Safeguard System,” filed by Matthew Michael Gelineau, et al., on Jan. 10, 2023.
PCT Patent Application Serial No. PCT/US2022/075677, titled “Field Installable Light Curtain Side Status Module,” filed by Nick Olsen, et al., on Aug. 30, 2022.
U.S. patent application Ser. No. 17/823,312, titled “Field Installable Light Curtain Side Status Module,” filed by Nick Olsen, et al., on Aug. 30, 2022.
U.S. Provisional Application Ser. No. 63/260,728, titled “Field Installable Light Curtain Side Status Module,” filed by Nick Olsen, et al., on Aug. 30, 2021.
PCT Patent Application Serial No. PCT/US22/73804, titled “Field Installable Laser Alignment Tool,” filed by Matthew Michael Gelineau, et al., on Jul. 15, 2022.
U.S. patent application Ser. No. 17/812,925, titled “Field Installable Laser Alignment Tool,” filed by Matthew Michael Gelineau, et al., on Jul. 15, 2022.
U.S. Provisional Application Ser. No. 63/260,175, titled “Field Installable Light Curtain Side Status Module,” filed by Nick Olsen, et al., on Aug. 30, 2021.

This application incorporates the entire contents of the foregoing application(s) herein by reference.

### TECHNICAL FIELD

Various embodiments relate generally to safety control systems for industrial operations.

### BACKGROUND

Safety Communication Networks (SCNs) may be one of the essential parts of an industrial application to ensure the safe and secure operation of machinery, equipment, and workers. The SCNs may provide a way of transmitting critical safety-related information in real-time, and/or enabling swift and effective response to emergency situations. When the SCN fails to provide a secure and reliable network, in some cases, serious injuries or even fatalities may result.

In some examples, signals used in SCNs may be critical for ensuring the safe operation of industrial equipment. Diagnostic signals, for example, may allow real-time monitoring of system status. Safety signals may be used to trigger a shutdown of equipment in the event of an emergency, for example. For example, other signals used in SCNs may include status signals, which may indicate whether a device is in operation or not. In some examples, control signals may be used to control operation of devices in real-time.

The SCNs may be used in a wide range of safety devices (e.g., safety relays, safety controllers, and safety PLCs). These devices, for example, may be designed to detect potentially hazardous situations and take corrective action. For example, the safety device may shut down machinery or alert operators to potential hazards. Sometimes, a SCN may also include safety sensors (e.g., light curtains) to detect the presence of people or objects in the vicinity of machinery and trigger a safety response. For example, safety switches may be used to disable equipment in the event of an emergency.

### SUMMARY

Apparatus and associated methods relate to a remote safety input/output device configured to deliver both safety signals and sensor level diagnostics signals in an industrial safety communication network. In an illustrative example, a safety communication device (SCD) may include a safety port operably coupled to serially connected safety devices. The (SCD) may include pre-loaded safety signal profiles (SSPs) and an input system detection engine (ISDE). The ISDE may, for example, automatically identify a device type and a topological configuration of the serially connected safety devices based on a signal received at the safety port and the pre-loaded SSP. For example, when a safety device signal is received at the safety port, the ISDE may automatically identify whether the signal is a safety signal or a diagnostic signal. Various embodiments may advantageously provide plug-and-play installation of the safety devices to the industrial safety communication network.

Various embodiments may achieve one or more advantages. For example, some embodiments may include a local safety controller to advantageously provide fast safety response in critical applications. Some embodiments, for example, may advantageously optimize performance by dynamically configuring the safety port based on the topological configurations. For example, some embodiments may include a multifunction pin in the safety port to advantageously provide additional status information. Some embodiments, for example, may advantageously provide remote control capability for the safety controller. For example, some embodiments may advantageously configure an un-identified safety device as a default device to maintain a safety function of the un-identified safety device.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary remote safety input/output device (RSIOD) employed in an illustrative use-case scenario.

FIG. 2 is a block diagram depicting an exemplary RSIOD.

FIG. 3 is a block diagram depicting an exemplary four port RSIOD communicating with a safety controller using an exemplary pre-loaded mapping.

FIG. 4A, FIG. 4B, and FIG. 4C depict exemplary RSIODs in various safety device communication networks.

FIG. 5A and FIG. 5B depict exemplary RSIODs employed in various switch locking safety solutions.

FIG. 6 is a flowchart illustrating an exemplary RSIOD operation method.

FIG. 7 is a flowchart illustrating an exemplary safety controller operation method to communicate with an exemplary RSIOD.

FIG. 8 is a flowchart illustrating an exemplary RSIOD configuration method.

FIG. 9 is a flowchart illustrating an exemplary safety controller configuration method to communicate with an exemplary RSIOD.

Like reference symbols in the various drawings indicate like elements.

### DETAILED DESCRIPTION OF ILLUSTRATIVE EMBODIMENTS

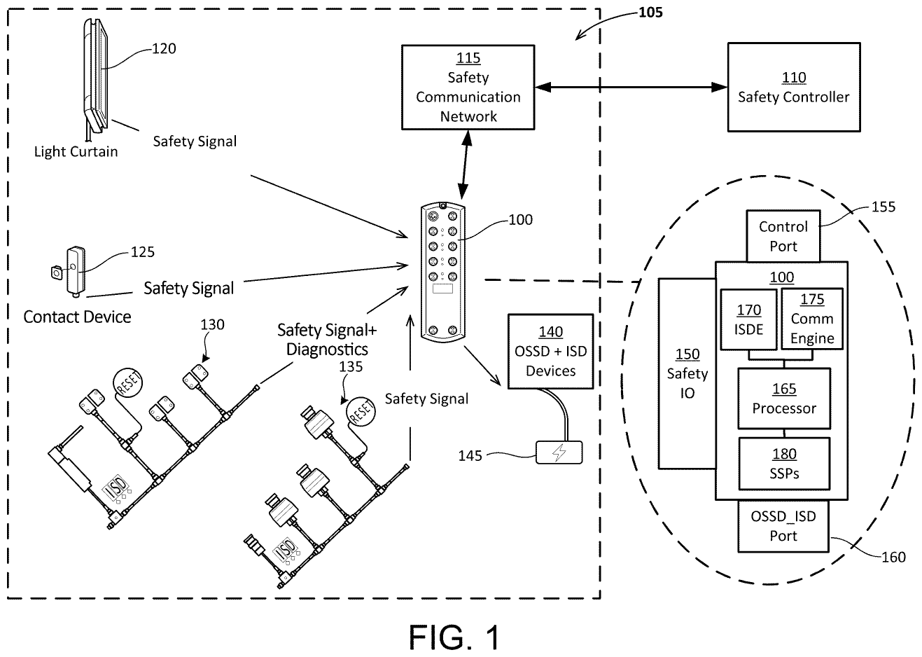

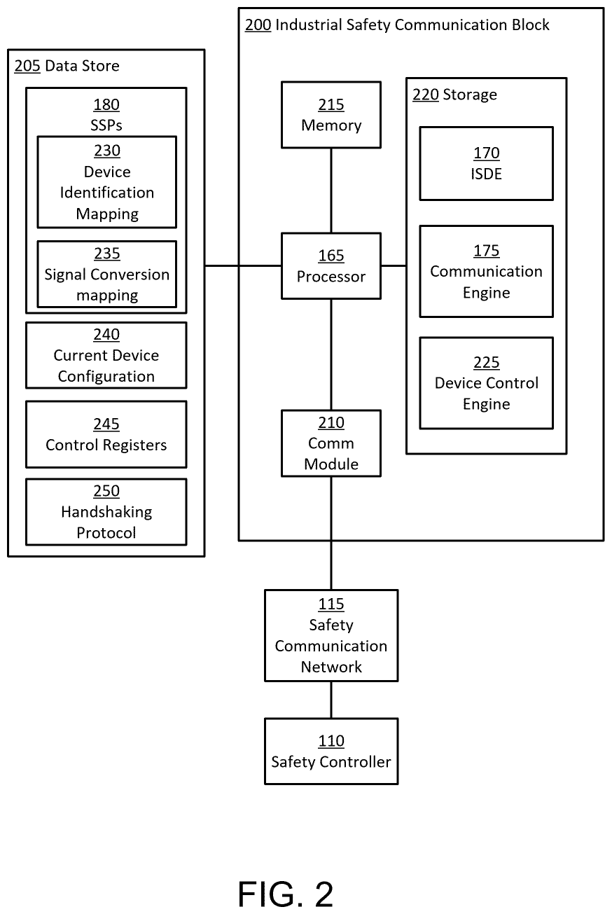

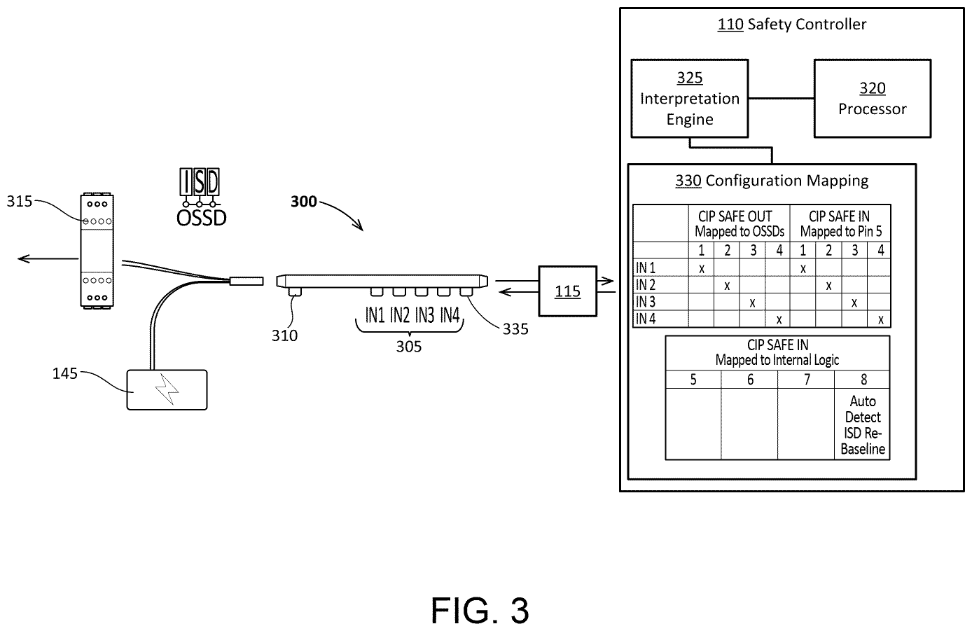

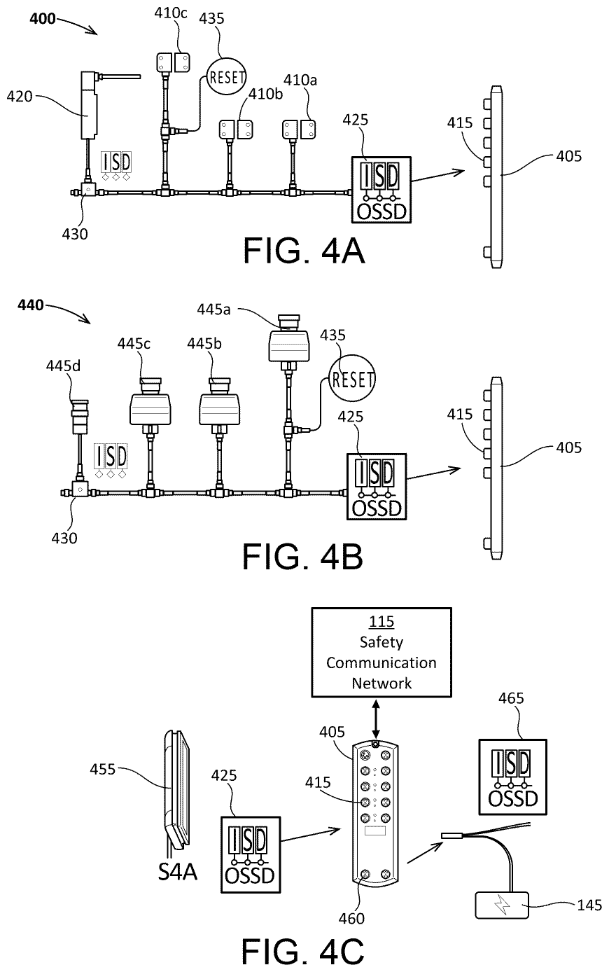

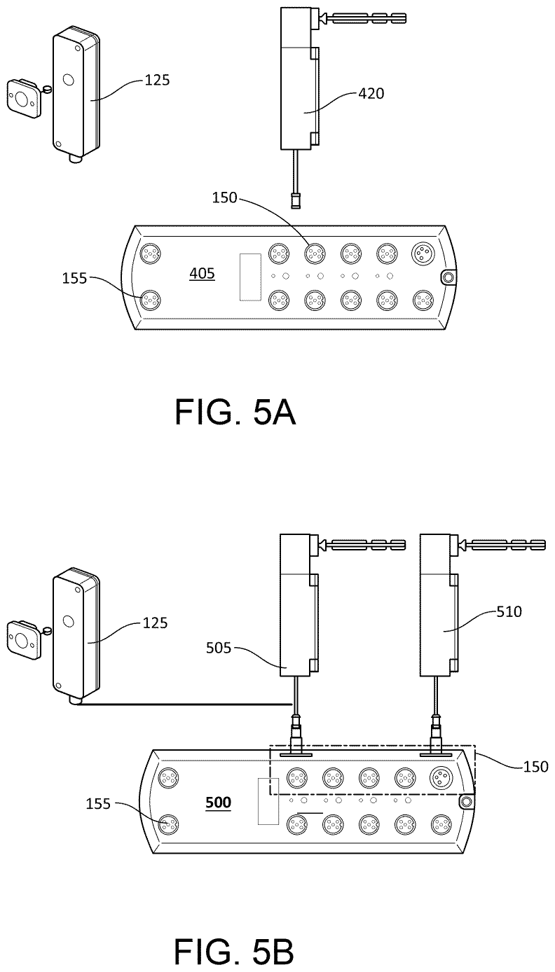

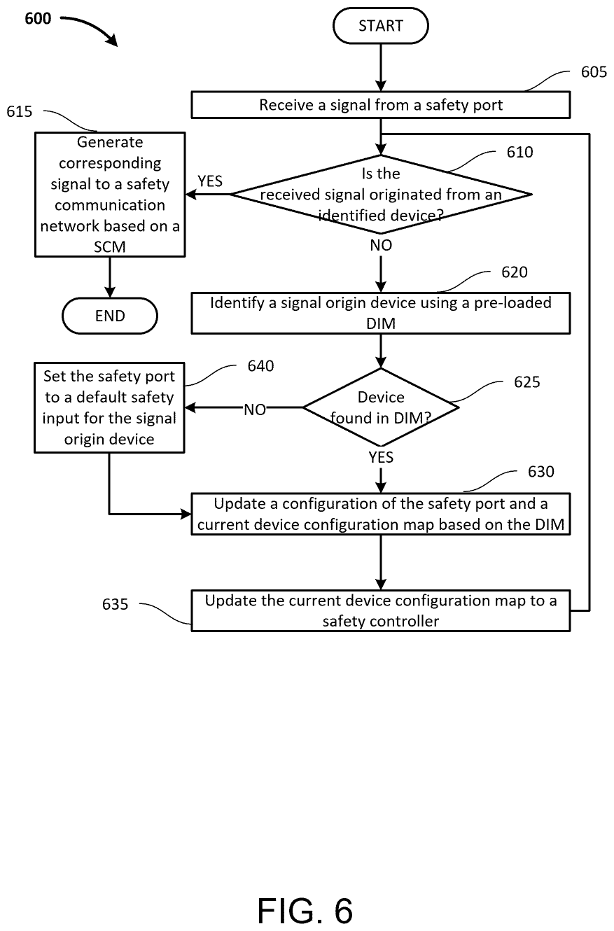

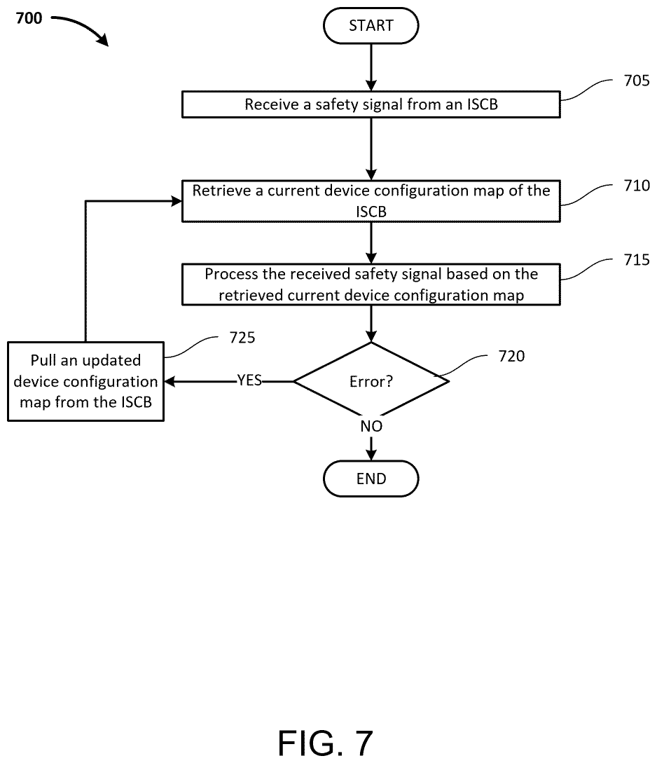

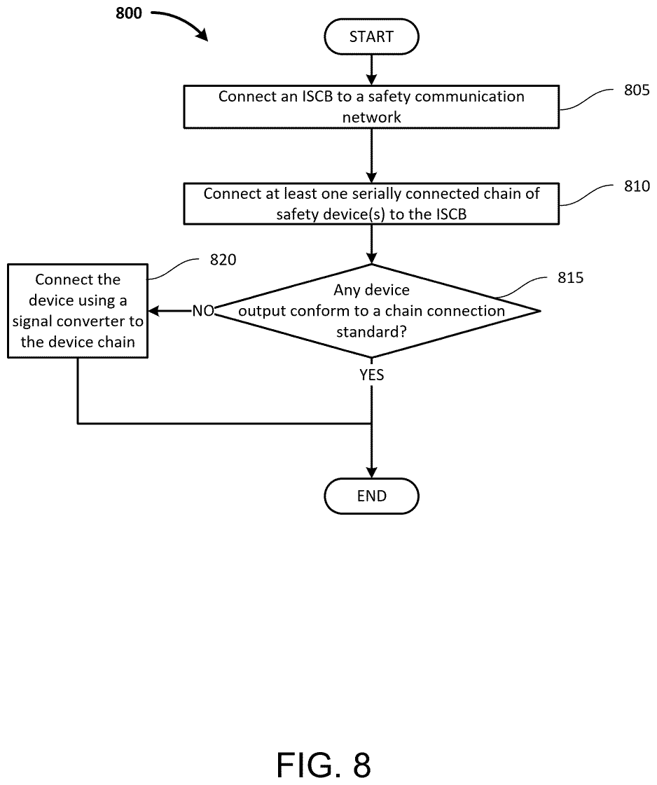

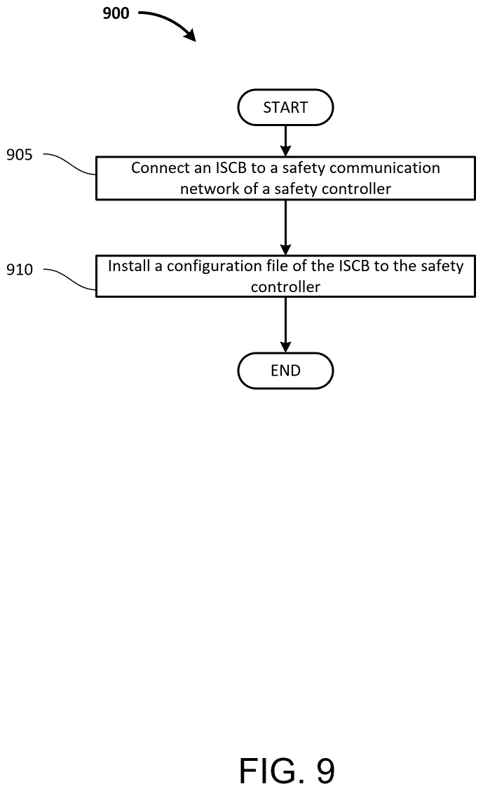

To aid understanding, this document is organized as follows. First, to help introduce discussion of various embodiments, a remote safety input/output device (RSIOD) is introduced with reference to FIGS. 1-2. Second, that introduction leads into a description with reference to FIG. 3 of some exemplary embodiments of communication system between the RSIOD and a safety controller. Third, with reference to FIGS. 4A-5B, various embodiments of the RSIOD are described in application to exemplary industrial safety applications. Fourth, with reference to FIGS. 6-7, the discussion turns to exemplary embodiments that illustrate operation methods of the RSIOD. Fifth, and with reference to FIG. 8-9, this document describes exemplary apparatus and methods useful for setting up a RSIOD in an industrial safety environment. Finally, the document discusses further embodiments, exemplary applications and aspects relating to RSIOD.

FIG. 1 depicts an exemplary remote safety input/output device (RSIOD 100) employed in an illustrative use-case scenario. In this example, the RSIOD 100 is employed in an industrial safety application 105. As shown the RSIOD 100 is connected to a safety controller 110 (e.g., a safety programmable logic controller (PLC)) via a safety network 115. For example, RSIOD 100 the safety devices may be auto-discoverable by the RSIOD 100 in a safety network (e.g., a PROFINET safety (PROFisafe) network, a Common Industrial Protocol safety (CIP SafetyTM) network, a Functional Safety over EtherCAT (FSoE) network). For example, the safety devices may provide safety information (e.g., a stop signal) and/or diagnostic information (e.g., working environment information). In some examples, the RSIOD 100 may allow safety devices to be hot pluggable to the safety network.

In some implementations, the safety network 115 may be a network environment certified with both safety standards body and with network standards body. For example, the safety network 115 may be operating on a functional safety communications protocol (FSCP). For example, the safety network 115 may conform to industry safety standards (e.g., IEC standards, IEC 61784-3 Industrial Communications Networks). In some implementations, the RSIOD 100 may generate a safe message according to a safety protocol of the safety network 115 to communicate with the safety controller 110. For example, the safe message may be generated using a predetermined safe message according to the safety protocol.

The RSIOD 100 is connected, in this example, to various safety devices. As shown, the industrial safety application 105 includes a light curtain 120, a contact device 125, a first safety signal and/or diagnostics (SSD 130), and a second safety signal and/or diagnostics (SSD 135). For example, the light curtain 120 may transmit a safety signal to the RSIOD 100 when an unauthorized object is detected to pass through the light curtain 120. The contact device 125, for example, may transmit a safety signal (e.g., lock/unlock) to the RSIOD 100. For example, the SSD 130 may include sensors (e.g., temperature sensors, contact sensors, distance sensors) connected in series. For example, each of the sensors may transmit diagnostic signals to the RSIOD 100. For example, each of the sensors may transmit safety signals to the RSIOD 100. For example, the diagnostics signals may include sensor health data. For example, the diagnostics data signals may also include sensor status data.

The SSD 135 may include, for example, emergency stops (e-stops). For example, the SSD 135 may transmit a safety signal to the RSIOD 100 indicating one or more e-stops are triggered. In some examples, the safety devices may include safety laser scanners and multifunction gate boxes. For example, the safety signal may include a safe on/off signal.

In some implementations, the RSIOD 100 may automatically identify a type of safety device that is connected. For example, based on the device type, the RSIOD 100 may convert signals between the safety devices and signals conformed to the safety network 115 (e.g., safety on-off signals to the contact device 125 and diagnostics signals from the light curtain 120).

In various implementations, the light curtain 120, the contact device 125, the SSD 130, and the SSD 135 may be connected to the RSIOD 100 using an in-series diagnostic standard. For example, the in-series diagnostics standard may allow the RSIOD 100 to daisy-chain multiple (e.g., 4, 8, 16, 32, 64, 128) devices with a 4-pin cable.

In this example, the RSIOD 100 is also connected to a serially connected output signal switching device in an in series device (ISD) chain (OSSD-ISD chain 140) and a power supply 145. The power supply 145, for example, may supply power to the RSIOD 100. In some implementations, the power supply 145 and the OSSD-ISD chain 140 may share a same input port.

In some implementations, the RSIOD 100 may transmit a control signal via the OSSD-ISD chain 140 to control a safety on-off signal of an (chain of) edge device(s) (e.g., robotic arm, machinery). For example, the RSIOD 100 may transmit, using the OSSD-ISD chain 140 a control signal independently to a specific one of the serially connected edge devices.

As an illustrative example without limitation, the safety controller 110 may receive the safety signal from the light curtain 120 via the RSIOD 100 and the safety network 115. Based on the safety signal, the safety controller 110 may transmit a message through the OSSD-ISD chain 140 to a machine to shut off the machine.

As shown, the RSIOD 100 includes at least one safety IO port 150 (e.g., four ports in this example, two ports, three ports, eight ports, in other examples), a control port 155, and an OSSD_ISD port 160. For example, the safety IO port 150 may be configured to receive signals (e.g., status signals, safety signals, diagnostic signals) from, and/or to transmit control signals to the safety devices. The control port 155, for example, may be configured to transmit and receive signals to and from the safety controller 110 via the safety network 115. The OSSD_ISD port 160 may be configured to, for example, communicate with the OSSD-ISD chain 140.

The RSIOD 100 further includes a processor 165 to process signals received from the safety controller 110 or the safety devices. The processor 165, in this example, is operably coupled to an input system detection engine (ISDE 170), a communication engine 175, and preloaded safety signal profiles (SSPs 180). In some implementations, the SSPs 180 may include mappings for converting diagnostic signals to messages in the safety network 115. For example, the RSIOD 100 may use the ISDE 170 to collect diagnostic data and transmit the diagnostic data in a predetermined format defined by the SSPs 180. For example, the SSPs 180 may be invariable (e.g., not configurable using an interface at the safety controller 110). In some implementations, a remote mapping data structure may be saved in the safety controller 110. For example, the remote mapping data structure may map the diagnostic data in a predetermined format into a logical and easy-to-use manner (e.g., into a standard data interchange formats including, for example, json, xml, yaml, csv) in the safety controller 110. Accordingly, the RSIOD 100 may advantageously simplify PLC programming.

In some implementations, the SSPs 180 may include one or more predetermined safety protocols. For example, the predetermined safety inputs and outputs may be mapped specifically to the safety IO ports 150. As an illustrative example without limitation, a CIP Safety output may be mapped to a pin of the one safety IO port 150. Various examples of input/output mapping are described further with reference to FIG. 3.

In some implementations, each of the safety IO port 150 may include configurable signal pins. For example, each signal pin may be configurable (e.g., as an input pin, an output pin, a data pin, an on/off pin, a power pin, a ground pin). For example, the signal pins may be automatically configured by the processor 165 based on an identification result of the ISDE 170.

In some implementations, the safety IO port 150 may include a multi-function pin. For example, the SSPs 180 may include a library of configurations. For example, the 100 may receive identification information (e.g., an ISD identifier) from a device (e.g., at the multi-function pin, from on/off input signal, from an encoded message). For example, the ISDE 170 may decode and match the received identification to one or more configurations in the library. As an illustrative example without limitation, the library may include configuration to identify a specific light curtain, and a generic light curtain. For example, after identifying the specific light curtain, the RSIOD 100 may use the multi-function pin to convey extra information to and from the safety controller 110. When the ISDE 170 identifies that a device is the generic light curtain, for example, the RSIOD 100 may still configure the input/output pin as standard safety and/or non-safety signal pins to maintain safety functionality in the industrial safety application 105. In some examples, the RSIOD 100 may configure the pins for non-safety status.

In various implementations, the communication engine 175 may be configured to use Fieldbus-specific processes to establish standard and safe connection settings. For example, the communication engine 175 may identify safety and non-safety addresses in the industrial safety application 105. For example, the RSIOD 100 may include a safety configuration mapping of the industrial safety application 105. Using the safety configuration mapping, the communication engine 175 may establish standard and safe connection settings.

In some implementations, based on the standard and safe connection settings, the RSIOD 100 may automatically identify safety device chains (e.g., the SSD 130, the SSD 135). For example, the RSIOD 100 may be configured to send safety communication signals using a safety network (e.g., the OSSD, CIP Safety). For non-safety communication signals (e.g., diagnostic information), for example, the RSIOD 100 may send over standard connection settings (e.g., Ethernet Industrial Protocol (Ethernet/IPTM is a trademark of ODVA, INC headquartered in Ann Arbor, MI)).

In various implementations, the RSIOD 100 may be preconfigured to automatically identify edge devices (e.g., safety devices and non-safety devices) connected to the RSIOD 100. For example, the industrial safety application 105 may include multiple RSIOD s that may connect to different safety zones of the industrial safety application 105. For example, each of the RSIOD 100 may connect to safety devices in corresponding safety zones to receive and transmit safety and diagnostic information to and from the safety controller 110 without the need to individually configure the RSIOD s.

In various implementations, a remote safety input/output device (e.g., the RSIOD 100) in a safety and diagnostic network (e.g., the safety network 115) may include an input system detection engine (e.g., the ISDE 170), and pre-loaded safety signal profiles (e.g., the SSPs 180). For example, a control port (e.g., the control port 155) may be operably coupled to a safety controller (e.g., the safety controller 110). A safety IO port (e.g., one or more of the safety IO ports 150) may be configured to serially connect one or more safety devices (e.g., the light curtain 120, the contact device 125, the SSD 130, the SSD 135). For example, the ISDE may be configured to automatically identify a configuration and/or types of devices that are serially connected to the remote safety input/output device. For example, the type of the devices of each of the serially connected devices may be identified based on the SSPs. In some implementations, when a signal is received at the safety IO port, the ISDE may automatically identify a signal origin device of the signal. The remote safety input/output device may convert the received signal into a safety signal or a diagnostic signal and transmit the converted signal to the safety controller over the safety and diagnostic network, for example.

In some implementations, more than one safety device may be serially connected to the remote safety input/output device by a single 5 pin cable. For example, four pins of the cable may carry safety signals. For example, the fifth pin may be configured as input, I/O, or output such as, by way of example and not limitation, based on device type. Accordingly, for example, the RSIOD 100 may advantageously reduce wiring cost by having serially connected safety devices to share a common network cabling. For example, various point-to-point cabling from one of the safety devices to the safety controller may be eliminated. In some examples, by automatically detecting the connected safety devices, the RSIOD 100 may advantageously reduce downtime (and/or changeover time) due to installation of the RSIOD 100. In some examples, the RSIOD 100 may provide a standard communication interface to advantageously allow a control engineer to do all logic at the safety controller. In some examples, RSIOD 100 may advantageously enable standard edge devices (e.g., encoders, drives, robots) to communicate with the safety controller 110 with embedded safe communication protocols of the safety network 115. In this way, the RSIOD 100 may further improve safety in the industrial safety application 105.

FIG. 2 is a block diagram depicting an exemplary RSIOD. A RSIOD 200 (e.g., such as the RSIOD 100 disclosed at least with reference to FIG. 1) includes the data store 205 and the processor 165. The processor 165 may, for example, include one or more processors. For example, the RSIOD 100 may include a processor per safety port. The RSIOD 100 may include a processor per two safety ports, for example. For example, the RSIOD 100 may include a processor per four safety ports.

The processor 165 is operably coupled to a communication module 210. The communication module 210 may, for example, include wired communication. The communication module 210 may, for example, include wireless communication. In the depicted example, the communication module 210 is operably coupled to the safety network 115. In the depicted example, the communication module 210 is operably coupled to the safety controller 110 via the safety network 115.

The processor 165 is operably coupled to a memory module 215. The memory module 215 may, for example, include one or more memory modules (e.g., random-access memory (RAM)). The RSIOD 200 includes a storage module 220. The storage module 220 may, for example, include one or more storage modules (e.g., non-volatile memory). In the depicted example, the storage module 220 includes the ISDE 170, the communication engine 175, and a device control engine (DCE 225). For example, the ISDE 170 may automatically identify a device type based on a signal received at the safety port 150. For example, the communication engine 175 may generate a control signal at the control port 155. The DCE 225, for example, generates a control signal to a safety device based on a signal received from the safety controller 110.

The data store 205 includes the SSPs 180. The SSPs 180 includes a device identification mapping (DIM 230) and a signal conversion mapping (SCM 235). For example, the ISDE 170 may automatically identify a device type of a signal origin device (e.g., the light curtain 120, the contact device 125, the SSD 130, the SSD 135) based on the DIM 230. For example, the communication engine 175 may generate a signal to the safety controller 110 over the safety network 115 based on the SCM 235.

The data store 205, in this example, also includes a current device configuration 240, control registers 245, and a handshaking protocol 250. For example, the ISDE 170 may update the current device configuration 240 based on an identified device connected to the RSIOD 200. For example, the current device configuration 240 may include a topological configuration of safety devices connected to the safety IO ports 150.For example, the RSIOD 200 may include one or more 5-pin safety inputs. For example, pins 1-4 of each safety input may be used for power and/or safety inputs (e.g., OSSD safety inputs). Pin 5, for example, may be dynamically configured based on the identified input type.

In some implementations, the ISDE 170 may identify equivalent devices (e.g., light curtain, sensors, locking switch) based on the DIM 230. For example, if a standard OSSD device is identified, the pin-5 may be off. If a device with a weak signal status via pin-5 is detected, for example, the pin-5 may be configured for weak signal diagnostic output. If an OSSD locking switch with pin-5 lock control is detected, for example, the pin-5 may be used to send 24 volts to the locking switch via a pre-mapped safety protocol input. In various implementations, the pin configurations for each of the safety inputs may be saved to the current device configuration 240. For example, when the ISDE 170 identifies an ISD locking switch, the ISDE 170 may update the current device configuration 240 that pin 5 of the safety input be specifically for transmitting a lock/unlock command.

The control registers 245, for example, may be remotely configurable. For example, the control registers 245 may be configurable by the safety controller 110. For example, based on values stored in the control registers 245, the communication engine may generate output signals at the safety port. Accordingly, one or more of the serially connected safety devices may advantageously be remotely controllable by the safety controller 110.

The handshaking protocol 250, for example, may be used for communicating predetermined messages with the safety controller 110. For example, the RSIOD 200 may transmit a status message (e.g., an error message from a robotic arm, a status message from a light curtain) to the safety controller 110 based on the handshaking protocol 250.

As an illustrative example without limitation, the RSIOD 200 may, upon receiving an unidentified signal, identify an OSSD input from one of the safety inputs. For example, the processor 165 may then auto-look for a newly connected ISD chain (e.g., the SSD 130). As an illustrative example, the ISDE 170 may identify a new specific light curtain from the unidentified signal (e.g., the unidentified signal has an active pin 5 signal and/or sending a hi/lo signal identifying that it is a specific light curtain). In some examples, a second unidentified signal may include a weak signal. For example, the ISDE 170 may monitor whether data is present. Using the data, for example, the ISDE 170 may use the SSPs 180 to perform an inquiry to determine what device is there. For example, the second unidentified signal may indicate that it is an ISD chain with a lot of data. After identifying types of the devices, the ISDE 170 may generate the updated current I/O Pin configuration indicating that the first input may include a light curtain with no smarts, and the second input includes an ISD chain with lots of data, for example.

FIG. 3 is a block diagram depicting an exemplary four port RSIOD 300 communicating with a safety controller 110 using an exemplary pre-loaded mapping (e.g., the SSPs 180). As shown, the RSIOD 300 may include four 5-pin input ports 305 and an OSSD output port 310. The OSSD output port 310 may be connected to the power supply 145 and a local safety controller 315. For example, if one of the 5-pin input ports 305 is connected to a standard OSSD device, the ISDE 170 (not shown) may turn the pin 5 of the 5-pin input ports 305 off. For example, when each safety device connected at one of the safety ports 305 is an input device, the ISDE 170 may mute an output function of the corresponding safety port and operate the safety port as an input port.

If the ISDE 170 identifies an ISD device, the ISDE 170 may configure the pin 5 to operate in an automatic detection mode. For example, if the ISDE 170 identified an OSSD light curtain with a weak signal status via pin-5, the ISDE 170 may utilize pin-5 for weak signal diagnostic output. If the ISDE 170 may identify an OSSD locking switch with pin-5 lock control, for example, the 170 may engage this pin to send 24 volts to the locking switch via a pre-mapped safety protocol input.

For example, the-pin input ports 305 may include ISD technology. For example, the ISD technology may allow sensor-level diagnostics to be transmitted over safety OSSD wires to provide safe on/off plus advanced diagnostics over two pins at any of the 5-pin input ports 305. For example, the RSIOD 300 may automatically identify a chain of safety devices by automatically detecting the number of devices and device type for up to 32 ISD devices connected to one of the -pin input ports 305.

The local safety controller 315 may, in some implementations, aggregate (e.g., using a logic AND) safety signals received at the 5-pin input ports 305. For example, the local safety controller 315 may provide, instead of making decisions by the safety controller 110 over the safety network 115, local safety control. In some implementations, the local safety controller 315 may generate an emergency stop signal based on the aggregated signal. For example, the local safety controller 315 may advantageously provide a fast (e.g., fastest possible) response time for critical applications (e.g., safety light curtain).

The safe inputs (e.g., all or some depending on a model of the local safety controller 315), for example, may trigger a safe solid-state output. The OSSD output port 310 may be a pair of pins in some implementations. In some implementations, the OSSD output port 310 may be a 5-pin port that provides power to the RSIOD 300 while providing solid-state outputs. For example, the 5-pin port may receive data. For example, the 5-pin port may receive switchable power. For example, the 5-pin port may include a ground pin. For example, the 5-pin port may include on/off outputs. For example, the 5-pin port may include safety inputs.

In this example, the RSIOD 300 is connected to the safety controller 110 via the safety network 115 (e.g., an Ethernet/IP network). The safety controller 110 includes, in this example, a processor 320. The processor 320 is coupled to an interpretation engine 325. For example, the interpretation engine 325 may be installed using a configuration file corresponding to the RSIOD 300. The interpretation engine 325 may, based on a mapping stored in the RSIOD 300, generate a configuration mapping 330. For example, the configuration mapping 330 may include mapping of safety signals, diagnostic signals, and/or other signals transmitted from the 300 related to each of the 5-pin input ports 305. Using the configuration mapping 330, the safety controller 110 may interpret an origin and/or meaning of a received signal from the RSIOD 300. In some implementations, the configuration mapping 330 may be automatically updated by pulling information from the RSIOD 300. In some implementations, the configuration mapping 330 may be updated when the RSIOD 300 pushes update to the safety controller 110. In various implementations, when the safety controller 110 receives a signal from a control IO port, for example, the signal may be processed based on the configuration mapping 330.

As shown, the RSIOD 300 also includes an output port 335. For example, the output port 335 may be an ethernet switch for daisy chained remote safety input/output devices.

FIG. 4A, FIG. 4B, and FIG. 4C depict exemplary RSIODs in various safety device communication networks. As shown in FIG. 4A, a device chain 400 is serially connected to a safety input 415 of the RSIOD 405. The device chain 400 includes contact sensors 410a, 410b, 410c and a distance sensor 420. For example, the device chain 400 may include other devices serially connected to the chain. As shown, diagnostic signals are transmitted to the RSIOD 405 using an ISD network standard 425. In some implementations, the RSIOD 405 may automatically configure the safety IO port 150 into the safety input 415 when the RSIOD 405 determines that the sensors 410a, 410b, 410c, and the distance sensor 420 are input devices. In various implementations, chain connection standards other than the ISD network standard 425 may be used.

In this example, the distance sensor 420 may be a generic sensor. For example, the distance sensor 420 may transmit a signal that may be non-compliant to the ISD network standard 425. The device chain 400 further includes a signal converter 430 to convert the signal of the distance sensor 420 into the ISD network standard 425.

The contact sensor 410c includes a reset button 435. For example, the contact sensor 410c may transmit a reset signal generated by the reset button 435 in addition to an on/off signal based on a contact detection of the contact sensor 410c.

As shown in FIG. 4B, a device chain 440 is serially connected to the safety input 415 of the RSIOD 405. In this example, the device chain 440 includes e-stops 445a, 445b, 445c, 445d. The e-stops 445a, 445b, 445c, 445d transmit safety signals to the RSIOD 405 using the ISD network standard 425. As shown, the e-stop 445d is connected to the signal converter 430 to the ISD network standard 425. In some implementations, the device chain 440 may be serially connected to the device chain 400 and to the safety input 415. For example, the ISDE 170 of the RSIOD 405 may automatically identify the device types and/or configuration of each device in a device chain of the device chain 400 and the device chain 440.

As shown in FIG. 4C, a light curtain 455 is serially connected to the safety input 415 of the RSIOD 405 via the ISD network standard 425. In some implementations, the light curtain 455 may be serially connected to the device chain 400 and/or the device chain 440. For example, the ISDE 170 of the RSIOD 405 may automatically identify the device types and/or configuration of each device in a device chain of the device chain 400. the device chain 440, and the light curtain 455.

The RSIOD 405 includes an output port 460. For example, the output port 460 may be configured to transmit a safety control signal using a ISD OSSD interface 465. For example, the RSIOD 405 may connect to an emergency shutdown controller through the ISD OSSD interface 465. As shown, the RSIOD 405 may receive power from the power supply 145 via the output port 460.

As shown, the RSIOD 405 is connected to the safety network 115. In some examples, the RSIOD 405 may transmit a signal to the safety controller 110 (FIG. 1) via the safety network 115. For example, the light curtain 455 may transmit a safety signal to the RSIOD 405 when an unauthorized object is detected. Upon receiving the safety signal, the RSIOD 405 may generate a safety status signal to the safety controller 110 through the safety network 115. The safety controller 110 may, for example, generate a stop signal based on the safety status signal. In response to receiving the stop signal, the RSIOD 405 may generate a control signal to stop machinery behind the light curtain 455 using the ISD OSSD interface 465.

FIG. 5A and FIG. 5B depict exemplary RSIOD s employed in various switch locking safety solutions. As shown in FIG. 5A, the RSIOD 405 is connected to the distance sensor 420 that is serially connected to the contact device 125. For example, the RSIOD 405 may receive command from the safety controller 110 to lock/unlock a door based on a sensor measurement received from the distance sensor 420. In some implementations, after connecting the contact device 125 and the distance sensor 420 to the RSIOD 405, the ISDE 170 may automatically configure the safety IO port 150 into an input/output port. In some implementations, the ISDE 170 may configure the safety IO ports 150 based on signals received from the distance sensor 420 and the contact device 125. For example, the ISDE 170 may configure the safety IO ports 150 with one safety output pin, one safety input pin, and one lock status pin. For example, the lock status pin may be the multifunction pin.

As shown in FIG. 5B, a RSIOD 500 includes four safety IO ports 150. In this example, one of the safety IO ports 150 is serially connected to a first sensor 505 and the contact device 125, and another safety IO port 150 is connected to a second sensor 510. In this example, based on an automatically detected input configuration, the ISDE 170 may configure the safety IO ports 150 to have four safety output pins, four safety input pins (e.g., lock/unlock signal), and a lock status pin.

FIG. 6 is a flowchart illustrating an exemplary RSIOD operation method 600. For example, the processor 165 may use the ISDE 170 and the communication engine 175 to perform the 600 to operate the RSIOD 100. In this example, the method 600 begins when a signal is received from a safety port in step 605. For example, the RSIOD 100 may receive a signal from the SSD 130 at the safety IO port 150.

In a decision point 610, it is determined whether the received signal originated from an identified device. For example, the ISDE 170 may determine whether a signal origin device is previously identified based on the current device configuration 240. If it is determined that the received signal originated from an identified device, in step 615, a corresponding signal is generated to a communication network based on a SCM, and the method 600 ends. For example, the processor 165 may use the communication engine 175 to generate a signal corresponding to the received signal based on the SCM 235 of the SSPs 180.

If it is determined that the received signal does not originate from an identified device, a signal origin device (SOD) is identified in step 620. For example, the ISDE 170 may identify the SOD based on the DIM 230. For example, the DIM 230 may be predefined in a manufacturing process of the RSIOD 100.

Next, in a decision point 625, it is determined whether the identified device is found in the DIM. For example, the identified SOD may be a generic safety device not defined in the DIM 230. If the identified device is found in the DIM, in step 630, a configuration of the safety port and a current device configuration map is updated based on the DIM. For example, the ISDE 170 may reconfigure input/output settings (e.g., a safety pin, a diagnostic pin, a status pin) of pins of the safety port 150. For example, the ISDE 170 may update the current device configuration 240. Next, the current device configuration map is updated to a safety controller in step 635, and the decision point 610 is repeated. For example, the RSIOD 100 may push an updated current device configuration 240 to the safety controller 110. If the identified device is not found in the DIM, in step 640, the safety port is set to a default safety input for the SOD, and the step 630 is repeated.

FIG. 7 is a flowchart illustrating an exemplary safety controller operation method 700 to communicate with an exemplary RSIOD (e.g., the RSIOD 100). For example, the processor 320 of the safety controller 110 may perform the exemplary safety controller operation method 700. In this example, the method 700 begins when a safety signal is received from a RSIOD in step 705. For example, the safety controller 110 may receive a safety signal from the RSIOD 100 via the safety network 115.

Next, a current device configuration map of the RSIOD is retrieved in step 710. For example, the safety controller 110 may retrieve the configuration mapping 330 corresponding to the four port RSIOD 300. In step 715, the received safety signal is processed based on the retrieved current device configuration map. For example, the processor 320 may use the interpretation engine 325 to process a received signal based on the configuration mapping 330.

In a decision point 720, it is determined whether there is an error. For example, the interpretation engine 325 may generate an error when a signal is undefined. If there is no error, the method 700 ends. If there is an error, in step 725, an updated device configuration map is pulled from the RSIOD, and the step 710 is repeated.

FIG. 8 is a flowchart illustrating an exemplary RSIOD configuration method 800. For example, a control engineer may perform the method 800 to set up the RSIOD 100 in the industrial safety application 105. In this example, the method 800 begins in step 805 when a RSIOD is connected to a safety communication network. For example, the RSIOD 100 is connected to the safety network 115. Next, in step 810, at least one serially connected chain of safety device(s) is connected to the RSIOD. For example, the SSD 130 is connected to the RSIOD 100. For example, the contact device 125 is connected to the RSIOD 100.

In a decision point 815, it is determined whether a device output conforms to a chain connection standard. For example, the device output may be an output of the contact sensors 410a that may conform to the chain connection standard (e.g., the ISD network standard 425). For example, the device output of the distance sensor 420 may be non-conforming to the chain connection standard. If it is determined that the device output conforms to a chain connection standard, the method 800 ends. If it is determined that any device output does not conform to a chain connection standard, in step 820, the device is connected using a signal converter (e.g., the signal converter 430) to the device chain, and the method 800 ends.

FIG. 9 is a flowchart illustrating an exemplary safety controller configuration method 900 to communicate with an exemplary RSIOD. For example, a control engineer may optionally use the exemplary safety controller configuration method 900 to configure the safety controller 110 when a RSIOD is installed in the industrial safety application 105, in some implementations. In this example, the method 900 begins in step 905, when a RSIOD is connected to a safety communication network of a safety controller. For example, the RSIOD 100 is connected to the safety network 115. Next, in step 910, a configuration file of the RSIOD is installed to the safety controller, and the method 900 ends. For example, the interpretation engine 325 may be installed to the safety controller 110. For example, the interpretation engine 325 may generate the configuration mapping 330 based on information retrieved from the four port RSIOD 300.

Although various embodiments have been described with reference to the figures, other embodiments are possible.

In some implementations, the RSIOD 100 may be configured as a plug-n-play module in the safety network 115 that may communicate safety and/or diagnostic information to and from a safety PLC without configuration. Accordingly, the RSIOD 100 may advantageously simplify installation, for example. In some examples, the RSIOD 100 may advantageously provide a requisite robustness of a safety communication protocol while still delivering advanced sensor-level diagnostics.

In some implementations, the RSIOD 100 may connect to other destination devices through the safety network 115. For example, the RSIOD 100 may be connected to other RSIOD through the safety network 115. In some examples, the RSIOD 100 may be connected to a safety relay through the safety network 115. In some implementations, the safety network 115 may be connected to cloud data services. For example, an organization of the industrial safety application 105 may use the cloud data services to retrieve information from the safety devices via the RSIOD 100. For example, the cloud data service may process the data to generate real-time analytics, machine learning, and artificial intelligence (AI) decisions.

Although an exemplary system has been described with reference to FIGS. 1-5, other implementations may be deployed in other industrial, scientific, medical, commercial, and/or residential applications.

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Computer program products may contain a set of instructions that, when executed by a processor device, cause the processor to perform prescribed functions. These functions may be performed in conjunction with controlled devices in operable communication with the processor. Computer program products, which may include software, may be stored in a data store tangibly embedded on a storage medium, such as an electronic, magnetic, or rotating storage device, and may be fixed or removable (e.g., hard disk, floppy disk, thumb drive, CD, DVD).

Although an example of a system, which may be portable, has been described with reference to the above figures, other implementations may be deployed in other processing applications, such as desktop and networked environments.

Temporary auxiliary energy inputs may be received, for example, from chargeable or single use batteries, which may enable use in portable or remote applications. Some embodiments may operate with other DC voltage sources, such as a 9V batteries, for example. Alternating current (AC) inputs, which may be provided, for example from a 50/60 Hz power port, or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

Although particular features of an architecture have been described, other features may be incorporated to improve performance. For example, caching (e.g., L1, L2, . . . ) techniques may be used. Random access memory may be included, for example, to provide scratch pad memory and or to load executable code or parameter information stored for use during runtime operations. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and CD-ROM and DVD-ROM disks. The processor and the memory can be supplemented by, or incorporated in, ASICs (application-specific integrated circuits).

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. Various embodiments may be implemented in a computer system that includes a graphical user interface and/or an Internet browser. To provide for interaction with a user, some implementations may be implemented on a computer having a display device. The display device may, for example, include an LED (light-emitting diode) display. In some implementations, a display device may, for example, include a CRT (cathode ray tube). In some implementations, a display device may include, for example, an LCD (liquid crystal display). A display device (e.g., monitor) may, for example, be used for displaying information to the user. Some implementations may, for example, include a keyboard and/or pointing device (e.g., mouse, trackpad, trackball, joystick), such as by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

In various embodiments, the computer system may include Internet of Things (IOT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAS, ASICs), or some combination thereof. In some embodiments, the module(s) may involve execution of preprogrammed instructions, software executed by a processor, or some combination thereof. For example, various modules may involve both hardware and software.

In some aspects, a safety communication system may include a safety controller (110) including a remote mapping data structure (330) and, a safety communication device (100) including: a control port (155) operably coupled to the safety controller via a safety communication network (115); a safety port (150) configured to couple to at least one safety device, wherein each of the at least one safety device is serially connected to the safety port; pre-loaded safety signal profiles (SSPs) (180), wherein the SSPs are predetermined and static in operation, and include a device identification mapping (230) and a signal conversion mapping (235); a communication engine (175) including a program of instructions configured to generate a control signal at the control port, an input system detection engine (ISDE) (170) includes a program of instructions configured to automatically identify a device type based on a signal received at the safety port, and a configuration of the at least one safety device serially connected to the safety port, wherein the device type includes a safety device and a diagnostic device; and, a processor (165) coupled to the control port, the safety port, the SSPs, the communication engine, and the ISDE such that, when a safety device signal is received from a signal origin device at the safety port, the processor executes the ISDE to automatically identify a device type of the signal origin device based on the device identification mapping, and, based on the device type and the safety device signal, the processor executes the communication engine to generate a signal to the safety controller over the safety communication network based on the signal conversion mapping, such that the signal is processed based on the remote mapping data structure.

Identifies a device type of the signal origin device may include identifying equivalent devices amongst the at least one safety device.

The safety communication system may include a control register remotely configurable by the safety controller, wherein the processor is configured to execute the communication engine to generate output signals at the safety port based on values in the control register, such that at least one serially connected safety device is remotely controllable by the safety controller.

The device type may include an input device, an output device, and an input/output device, wherein: when each of the at least one safety device at the safety port is identified as an input device, the ISDE mutes an output function of the safety port and operates the safety port as an input port.

The safety communication device may further include at least one safety port.

The safety port may include a dynamic signal pin dynamically configurable as at least one of an input pin and an output pin based on the identified device type of the signal origin device.

The signal conversion mapping may include a mapping to convert signals received from an unidentified device into at least a safety signal.

The communication engine may, for example, be further configured to transmit an update to the remote mapping data structure to the safety controller, such that the safety controller is configured to identify each of the at least one safety device connected to the safety port based on the updated remote mapping data structure.

The safety communication system may include a local safety controller serially connected to the safety port, wherein: the local safety controller is connected to a plurality of safety devices, and, based on an aggregation of safety signals received from the plurality of safety devices, the local safety controller is configured to generate a stop signal based on the aggregated safety signal, such that a fast response time for critical applications is provided.

In an illustrative aspect, a safety communication device may include: a control port (155) operably coupled to a safety communication network; a safety port (150) operably coupled at least one safety device, wherein each of the at least one safety device is serially connected to the safety port; pre-loaded safety signal profiles (SSPs) (180), wherein the SSPs include a device identification mapping (230) and a signal conversion mapping (235); a communication engine (175) including a program of instructions configured to generate a control signal at the control port; an input system detection engine (ISDE) (170) including a program of instructions configured to automatically identify a device type based on a signal received at the safety port, and a configuration of the at least one safety device serially connected to the safety port, wherein the device type includes a safety device and a diagnostic device; and, a processor (165) coupled to the control port, the safety port, the SSPs, the communication engine, and the ISDE such that, when a safety device signal is received from a signal origin device at the safety port, the processor executes the ISDE to automatically identify a device type of a signal origin device based on the device identification mapping, and based on the safety device signal, the processor executes the communication engine to generate a signal to a destination device over the safety communication network based on the signal conversion mapping.

The pre-loaded SSPs may, for example, be predetermined and static in operation.

Identifies a device type of a signal origin device may include, for example, identifying equivalent devices within the at least one safety device.

The safety communication device may, for example, further include a control register, wherein the processor is configured to execute the communication engine to generate control signals at the safety port based on values stored in the control register, such that at least one serially connected safety device is remotely controllable.

The device type may, for example, include an input device, an output device, and an input/output device, wherein when each of the at least one safety device at the safety port is identified as an input device, the ISDE mutes an output function of the safety port and operates the safety port as an input port.

The safety port may, for example, include a dynamic signal pin dynamically configurable as at least one of an input pin and an output pin based on the identified device type of the signal origin device.

The signal conversion mapping may include, for example, a mapping to map signals received from an unidentified device into at least a safety signal.

The safety communication device may, for example, further include a remote mapping data structure configured to be installed in a safety controller, wherein: when the safety controller receives a signal from the control port, the signal is processed based on the remote mapping data structure.

The communication engine may, for example, be further configured to transmit an update of the remote mapping data structure to the safety controller, such that the safety controller is configured to identify each of the safety devices connected to the safety port based on the updated remote mapping data structure.

The safety communication device, may, for example, further include an output switching signal device (OSSD) port, wherein the OSSD port is serially connect to a plurality of edge devices, wherein the OSSD port is configured to transmit a control signal independently to one of the plurality of edge devices.

The safety communication device, may, for example, further include four safety ports.

In some implementations, some or all of the operations performed by the system may be implemented in a computer program product. In some implementations, some or all of the operations performed by the system may be implemented in a computer implemented method.

In an illustrative aspect, some implementations may, for example, include any and/or any combination of [0091]-[0111].

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

1. A safety communication system comprising:
a safety controller (110) comprising a remote mapping data structure (330); and,
a safety communication device (100) comprising:
a control port (155) operably coupled to the safety controller via a safety communication network (115);
a safety port (150) configured to couple to at least one safety device, wherein each of the at least one safety device is serially connected to the safety port;
pre-loaded safety signal profiles (SSPs) (180), wherein the SSPs are predetermined and static in operation, and comprise a device identification mapping (230) and a signal conversion mapping (235);
a communication engine (175) comprising a program of instructions configured to
generate a control signal at the control port,
an input system detection engine (ISDE) (170) comprises a program of instructions configured to automatically identify a device type based on a signal received at the safety port, and a configuration of the at least one safety device serially connected to the safety port, wherein the device type comprises a safety device and a diagnostic device; and,
a processor (165) coupled to the control port, the safety port, the SSPs, the communication engine, and the ISDE such that, when a safety device signal is received from a signal origin device at the safety port, the processor executes the ISDE to automatically identify a device type of the signal origin device based on the device identification mapping, and, based on the device type and the safety device signal, the processor executes the communication engine to generate at least one of a safety signal and/or a diagnostic signal to the safety controller over the safety communication network based on the signal conversion mapping, such that the at least one of a safety signal and/or a diagnostic signal is processed based on the remote mapping data structure.

2. The safety communication system of claim 1, wherein identifies a device type of the signal origin device comprises identifying equivalent devices amongst the at least one safety device.

3. The safety communication system of claim 1, further comprises a control register remotely configurable by the safety controller, wherein the processor is configured to execute the communication engine to generate output signals at the safety port based on values in the control register, such that at least one serially connected safety device is remotely controllable by the safety controller.

4. The safety communication system of claim 1, wherein the device type further comprises an input device, an output device, and an input/output device, wherein:
when each of the at least one safety device at the safety port is identified as an input device, the ISDE mutes an output function of the safety port and operates the safety port as an input port.

5. The safety communication system of claim 1, wherein the safety communication device further comprises at least one safety port.

6. The safety communication system of claim 1, wherein the safety port comprises a dynamic signal pin dynamically configurable as at least one of an input pin and an output pin based on the identified device type of the signal origin device.

7. The safety communication system of claim 1, wherein the signal conversion mapping comprises a mapping to convert signals received from an unidentified device into at least a safety signal.

8. The safety communication system of claim 1, wherein the communication engine is further configured to transmit an update to the remote mapping data structure to the safety controller, such that the safety controller is configured to identify each of the at least one safety device connected to the safety port based on the updated remote mapping data structure.

9. The safety communication system of claim 1, further comprising a local safety controller serially connected to the safety port, wherein:
the local safety controller is connected to a plurality of safety devices, and, based on an aggregation of safety signals received from the plurality of safety devices, the local safety controller is configured to generate a stop signal based on the aggregated safety signal, such that a fast response time for critical applications is provided.

10. A safety communication device comprising:
a control port (155) operably coupled to the safety controller via a safety communication network (115);
a safety port (150) configured to couple to at least one safety device, wherein each of the at least one safety device is serially connected to the safety port;
pre-loaded safety signal profiles (SSPs) (180), wherein the SSPs are predetermined and static in operation, and comprise a device identification mapping (230) and a signal conversion mapping (235);
a communication engine (175) comprising a program of instructions configured to generate a control signal at the control port,
an input system detection engine (ISDE) (170) comprises a program of instructions configured to automatically identify a device type based on a signal received at the safety port, and a configuration of the at least one safety device serially connected to the safety port, wherein the device type comprises a safety device and a diagnostic device; and,
a processor (165) coupled to the control port, the safety port, the SSPs, the communication engine, and the ISDE such that, when a safety device signal is received from a signal origin device at the safety port, the processor executes the ISDE to automatically identify a device type of the signal origin device based on the device identification mapping, and, based on the device type and the safety device signal, the processor executes the communication engine to generate at least one of a safety signal and/or a diagnostic signal to the safety controller over the safety communication network based on the signal conversion mapping, such that the at least one of a safety signal and/or a diagnostic signal is processed based on the remote mapping data structure.

11. The safety communication device of claim 10, wherein the pre-loaded SSPs are predetermined and static in operation.

12. The safety communication device of claim 10, wherein identifies a device type of a signal origin device comprises identifying equivalent devices within the at least one safety device.

13. The safety communication device of claim 10, further comprising a control register, wherein the processor is configured to execute the communication engine to generate control signals at the safety port based on values stored in the control register, such that at least one serially connected safety device is remotely controllable.

14. The safety communication device of claim 10, wherein the device type further comprises an input device, an output device, and an input/output device, wherein when each of the at least one safety device at the safety port is identified as an input device, the ISDE mutes an output function of the safety port and operates the safety port as an input port.

15. The safety communication device of claim 10, wherein the safety port comprises a dynamic signal pin dynamically configurable as at least one of an input pin and an output pin based on the identified device type of the signal origin device.

16. The safety communication device of claim 10, wherein the signal conversion mapping comprises a mapping to map signals received from an unidentified device into at least a safety signal.

17. The safety communication device of claim 10, further comprising a remote mapping data structure configured to be installed in a safety controller, wherein: when the safety controller receives a signal from the control port, the signal is processed based on the remote mapping data structure.

18. The safety communication device of claim 17, wherein the communication engine is further configured to transmit an update of the remote mapping data structure to the safety controller, such that the safety controller is configured to identify each of the safety devices connected to the safety port based on the updated remote mapping data structure.

19. The safety communication device of claim 10, further comprising an output switching signal device (OSSD) port, wherein the OSSD port is serially connect to a plurality of edge devices, wherein the OSSD port is configured to transmit a control signal independently to one of the plurality of edge devices.

20. The safety communication device of claim 10, further comprising four safety ports.
